(19) United States
(12) Patent Application Publication
(10) Pub. No.: US 2024/0030433 A1
(43) Pub. Date: Jan. 25, 2024

(54) ELECTRODE ASSEMBLY, BATTERY, AND ELECTRICAL DEVICE

(71) Applicant: Ningde Amperex Technology Limited, Ningde (CN)

(72) Inventors: Hua WU, Ningde (CN); Mengjie WANG, Ningde (CN); Luran ZHANG, Ningde (CN)

(73) Assignee: Ningde Amperex Technology Limited, Ningde (CN)

(21) Appl. No.: 18/374,682

(22) Filed: Sep. 29, 2023

Related U.S. Application Data
(63) Continuation of application No. PCT/CN2021/084096, filed on Mar. 30, 2021.

(51) Int. Cl. H01M 4/525; H01M 50/595; H01M 10/04

(52) U.S. Cl. CPC H01M 4/525; H01M 50/595; H01M 10/0436; H01M 2004/021

(57) ABSTRACT

An electrode assembly includes a first electrode plate, a second electrode plate, and a separator located between the first electrode plate and the second electrode plate; the first electrode plate includes a first current collector and a first membrane disposed on the first current collector, and the first membrane is provided with a first tab groove; and the second electrode plate includes a second current collector and a second membrane disposed on the second current collector, the second membrane is provided with a blocking groove and an alignment region defined by the blocking groove, and a projection of the alignment region on the first electrode plate covers the first tab groove.

### CROSS-REFERENCE TO RELATED APPLICATION

This application is a continuation application of PCT international application No. PCT/CN2021/084096 filed on Mar. 30, 2021, the disclosure of which is hereby incorporated by reference in its entirety.

### TECHNICAL FIELD

This application relates to the technical field of energy storage, and in particular, to an electrode assembly, a battery, and an electrical device.

### BACKGROUND

As a device for converting chemical energy into electrical energy, batteries are widely used in new energy vehicles, energy storage power stations and other fields. A battery usually includes a battery case and an electrode assembly and an electrolyte disposed in the battery case. The electrode assembly includes a first electrode plate, a separator and a second electrode plate stacked in sequence. The first electrode plate and the second electrode plate are each provided with a tab groove for welding of a tab. Charging and discharging functions of the battery are achieved by the tabs welded in the tab grooves. The first electrode plate and the second electrode plate have opposite polarities.

When the second electrode plate is a positive electrode plate, in a process of a charge-discharge cycle, active lithium ions in the second electrode plate will be free and diffuse to the tab groove of the first electrode plate, resulting in a lithium plating phenomenon on the first electrode plate. In the related art, active substances at a portion of the second electrode plate corresponding to the tab groove of the first electrode plate are usually removed to form a groove, so as to prevent lithium plating.

However, the foregoing solution may reduce the thickness uniformity of the electrode assembly, and after several times of the charge-discharge cycle of the battery, the lithium plating phenomenon on the first electrode plate still exists, affecting the safety performance of the battery.

### SUMMARY

In view of the fact above, the embodiments of this application provide an electrode assembly, a battery, and an electrical device used for preventing free active lithium ions at a portion of a second electrode plate corresponding to a tab groove of a first electrode plate from diffusing to the first electrode plate, thus preventing lithium plating on the first electrode plate and improving the safety performance of the battery.

To achieve the foregoing objective, technical solutions provided by the embodiments in this application are as follows:
A first aspect of the embodiments in this application provides an electrode assembly. The electrode assembly includes a first electrode plate, a second electrode plate, and a separator disposed between the first electrode plate and the second electrode plate; the first electrode plate includes a first current collector and a first membrane disposed on the first current collector, and the first membrane is provided with a first tab groove; and
the second electrode plate includes a second current collector and a second membrane disposed on the second current collector, the second membrane is provided with a blocking groove and an alignment region defined by the blocking groove, and a projection of the alignment region on the first electrode plate covers the first tab groove.

In some embodiments, a bottom of the blocking groove is a surface of the second current collector.

In some embodiments, the blocking groove includes a first blocking groove extending along a length direction of the second electrode plate, and a second blocking groove and a third blocking groove connected to two ends of the first blocking groove respectively; and a first preset angle is formed between the second blocking groove and the first blocking groove, a second preset angle is formed between the third blocking groove and the first blocking groove, and ends of the second blocking groove and the third blocking groove facing away from the first blocking groove are aligned with edges of the second electrode plate along a width direction.

In some embodiments, the first preset angle and the second preset angle range from 85° to 95°.

In some embodiments, the blocking groove includes an annular groove, and the annular groove surrounds the alignment region.

In some embodiments, taking a plane parallel to the second electrode plate as a cross-section, the cross-section of the annular groove is in a polygonal shape, or the cross-section of the annular groove is in a circular shape.

In some embodiments, a width of the blocking groove ranges from 0.1 mm to 2 mm.

In some embodiments, the first electrode plate is a negative electrode plate, and the second electrode plate is a positive electrode plate.

In some embodiments, the second electrode plate is provided with an insulating film, and the insulating film covers the blocking groove and the alignment region.

In some embodiments, along the length direction of the second electrode plate, the insulating film is provided with a first edge and a second edge arranged opposite to each other, and a distance between the second edge and a groove edge of the blocking groove close to the second edge ranges from 1 mm to 4 mm.

In some embodiments, the insulating film further includes a third edge, one end of the third edge is connected to the first edge, and the other end of the third edge is connected to the second edge; and a distance between the third edge and a groove edge of the blocking groove close to the third edge ranges from 1 mm to 4 mm.

In some embodiments, a vertical distance between a groove edge of the blocking groove close to the first edge and the groove edge of the blocking groove to the second edge is D1, a vertical distance between the first edge and the second edge is D2, and a difference between D2 and D1 ranges from 2 mm to 8 mm.

A second aspect of the embodiments in this application provides a battery. The battery includes a case and the foregoing electrode assembly disposed in the case.

A third aspect of the embodiments in this application provides an electrical device. The electrical device includes the foregoing battery.

According to the electrode assembly, the battery, and the electrical device provided by the embodiments of this application, the second electrode plate is provided with the blocking groove, and the blocking groove can prevent active lithium located in the alignment region from being transmitted to the first tab groove along the second electrode plate, thereby avoiding the lithium plating phenomenon at the first tab groove and improving the safety performance of the battery.

In addition, compared with a technical solution of removing the alignment region in the related art, reduction of a thickness of a region where the first tab groove is located is avoided, thus improving the thickness uniformity of the whole electrode assembly, preventing the lithium plating phenomenon at the first tab groove, and improving the safety performance of the battery.

### BRIEF DESCRIPTION OF DRAWINGS

FIG. 1 is a section view of an electrode assembly in the related art;

FIG. 2 is a schematic structural diagram of an upper surface of a second electrode plate in the related art;

FIG. 3 is a schematic structural diagram of a lower surface of a second electrode plate in the related art;

FIG. 4 is an enlarged schematic diagram of a region A of FIG. 2;

FIG. 5 is a section view of an electrode assembly according to an embodiment of this application;

FIG. 6 is a first schematic structural diagram of an upper surface of a second electrode plate according to an embodiment of this application;

FIG. 7 is a first schematic structural diagram of a lower surface of a second electrode plate according to an embodiment of this application;

FIG. 8 is an enlarged schematic diagram of a region B of FIG. 6;

FIG. 9 is a second schematic structural diagram of an upper surface of a second electrode plate according to an embodiment of this application;

FIG. 10 is a second schematic structural diagram of a lower surface of a second electrode plate according to an embodiment of this application; and

FIG. 11 is an enlarged schematic diagram of a region C of FIG. 9.

The reference numerals are as follows:
10: First electrode plate; 11: First tab groove;
12: First tab; 13: First current collector;
14: First membrane; 15: Protective film;
20: Separator; 30: Second electrode plate;
31: Second current collector; 32: Second membrane;
33: Alignment region; 34: Blocking groove;
341: First blocking groove; 342: Second blocking groove;
343: Third blocking groove; 35: Insulating film;
351: First edge; 352: Second edge;
353: Third edge; 36: Groove;
37: Second tab groove; 38: Second tab;
43: Third segment;

### DETAILED DESCRIPTION

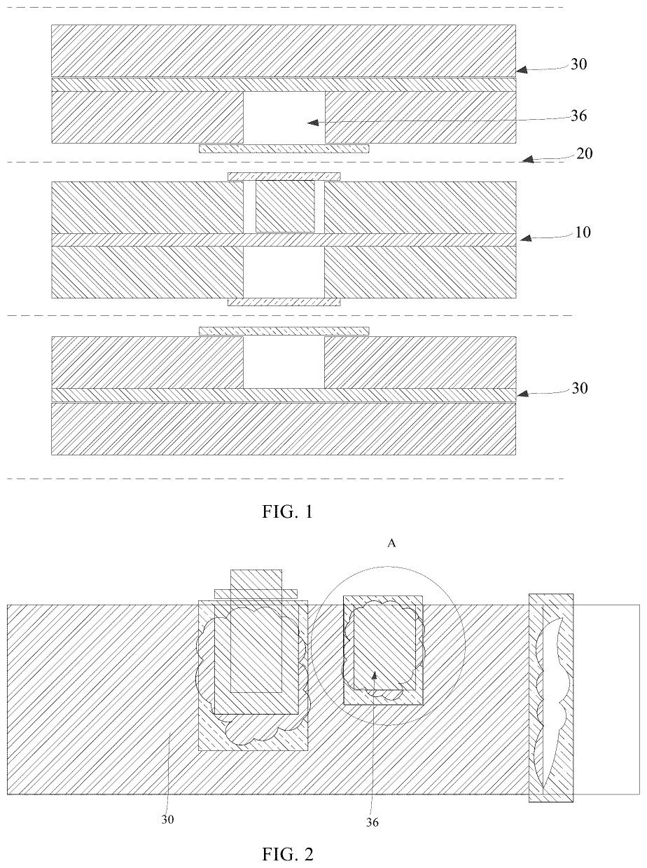

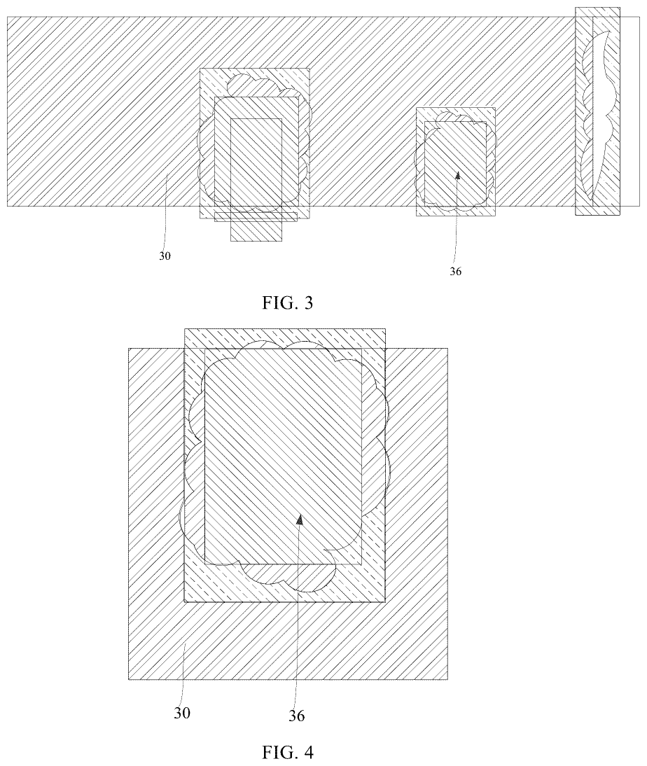

In the related art, as shown in FIG. 1 to FIG. 4, a groove 36 is generally provided in a portion of a second electrode plate 30 corresponding to a tab groove of a first electrode plate 10. The groove 36 prevents active lithium at the portion of the second electrode plate 30 corresponding to the tab groove of the first electrode plate 10 from diffusing to the tab groove of the first electrode plate 10, and further prevents a lithium plating phenomenon on the tab groove of the first electrode plate. However, the foregoing groove 36 may reduce a thickness of a region where the tab groove of the first electrode plate 10 is located, thus causing an electrode assembly to have an uneven thickness, and further affecting the film-forming of the second electrode plate. Therefore, after a plurality of cycles of a battery, the lithium plating phenomenon on the first electrode plate may still exist, and precipitated lithium may grow into lithium dendrites which easily puncture a separator to affect the safety performance of a battery.

In order to solve the above technical problems, embodiments of this application provide an electrode assembly, a battery, and an electrical device. A second electrode plate is provided with a blocking groove, and the blocking groove can prevent active lithium located in an alignment region from being transmitted to a first tab groove along the second electrode plate, thus preventing a lithium plating phenomenon at the first tab groove and improving the safety performance of the battery.

In addition, according to the embodiments of this application, a projection of the blocking groove on the first electrode plate does not overlap with the first tab groove, so that compared with a technical solution in the related art, in which the groove is provided at the portion of the second electrode plate corresponding to the tab groove of the first electrode plate, by means of the alignment region defined by the blocking groove, a thickness of a region where the first tab groove is located can be prevented from being reduced, the thickness uniformity of the whole electrode assembly is improved, and moreover, the transmission of active lithium in the alignment region can be blocked through the blocking groove, thus preventing the lithium plating phenomenon at the first tab groove and improving the safety performance of the battery.

For ease of understanding the foregoing purposes, features and advantages of the embodiments in this application, the following describes the technical solutions of the embodiments in this application clearly and thoroughly in conjunction with the drawings of the embodiments in this application. Apparently, the described embodiments are merely a part of the embodiments of this application, rather than all of the embodiments.

An embodiment of this application provides an electrical device. The electrical device may include a battery, and the battery is used to provide electric power for the electrical device. The electrical device in the embodiment of this application may be a vehicle, for example, the vehicle may be a fuel vehicle, a gas vehicle or a new energy vehicle, and the new energy vehicle may be a purely electric vehicle, a hybrid electric vehicle, a range extended vehicle or the like.

In addition, the electrical device may be other energy storage devices, such as a mobile phone, a portable device, a notebook computer, an electric toy, a power tool, a ship, and a spacecraft. The spacecraft may include an airplane, a rocket, a space shuttle, or a spaceship.

The battery described in the embodiments of this application is not limited to being applied to the foregoing described electrical device, but for the sake of simplicity of description, the following embodiments are all described by taking a mobile phone as an example.

Exemplarily, a mobile phone may include a phone body and a battery disposed in the phone body. The battery is connected to a circuit board of the phone body and used for providing power for the circuit board to ensure normal use of the mobile phone.

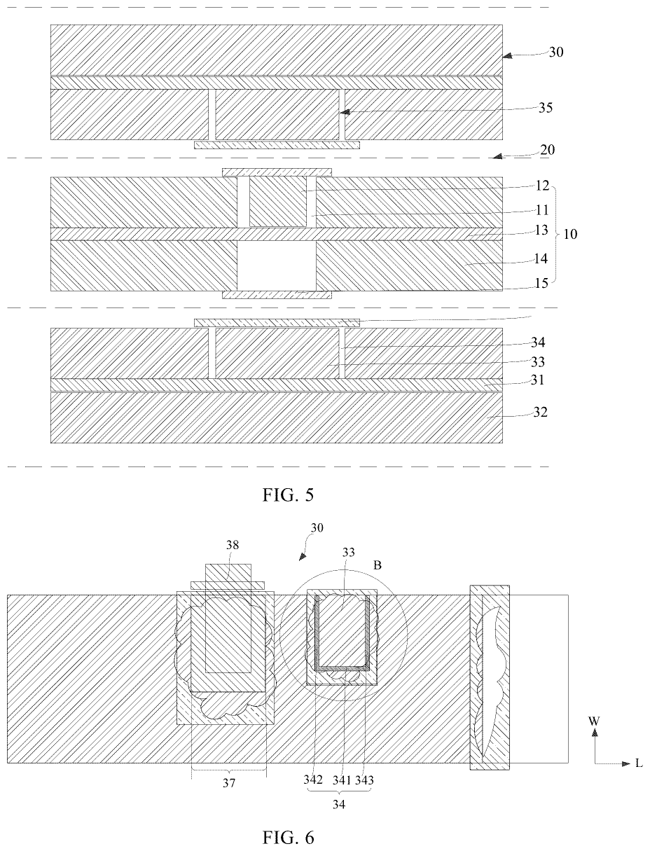

The battery may include a case and an electrode assembly and an electrolyte disposed in the case. As shown in FIG. 5, the electrode assembly may include a first electrode plate 10, a separator 20, and a second electrode plate 30, and the first electrode plate 10, the separator 20 and the second electrode plate 30 may be stacked in sequence and then wound around a preset winding shaft to form a winding structure.

The separator 20 is disposed between the first electrode plate 10 and the second electrode plate 30 close to each other, and is configured to achieve an insulation setting between the first electrode plate and the second electrode plate, wherein material of the separator 20 may be PP or PE.

It is to be noted that, in this embodiment, the first electrode plate 10 and the second electrode plate 30 have opposite polarities, and the first electrode plate 10 may be a negative electrode plate or a negative electrode plate. For convenience of description, the following embodiments are described by taking the first electrode plate 10 as a negative electrode plate, the second electrode plate 30 as a positive electrode plate and the battery as a lithium battery as an example.

With continued reference to FIG. 5, the first electrode plate 10 includes a first current collector 13 and first membranes 14, and the number of the first membranes 14 is two. The two first membranes 14 are disposed on an upper surface and a lower surface of the first current collector 13 respectively. Material of the first current collector 13 may be aluminum, and material of the first membranes 14 may be lithium cobalt oxide, lithium iron phosphate, ternary lithium or lithium manganate, etc.

The two first membranes 14 are each provided with a first tab groove 11. The first tab grooves 11 expose the first current collector 13, and a connecting line of centers of the two first tab grooves 11 is perpendicular to the first current collector 13.

A first tab 12 is disposed in one of the first tab grooves 11, and the first tab 12 may be electrically connected to a positive terminal on the case, so as to charge and discharge the battery.

In order to protect the first tab 12, protective films 15 may be disposed on the first electrode plate 10, and the protective films 15 cover the first tab grooves 11. The protective films may include protective adhesive tapes.

The second electrode plate 30 includes a second current collector 31 and second membranes 32, and the number of the second membranes 32 may be two. The two second membranes 32 may be disposed on an upper surface and a lower surface of the second current collector 31 respectively. Material of the second current collector 31 is copper, and material of the second membrane 32 includes carbon or silicon or the like.

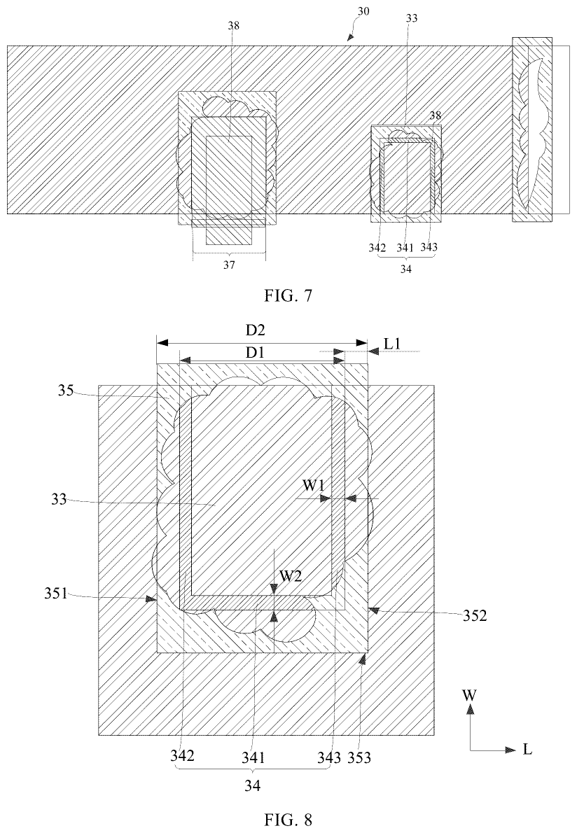

As shown in FIG. 6 and FIG. 7, the second electrode plate 30 may also be provided with a second tab groove 37, and a second tab 38 is disposed in the second tab groove 37. The second tab 38 is electrically connected to a negative terminal disposed on the case, and the positive terminal and the negative terminal on the case are respectively connected to a power supply device or an electrical device so as to realize the charging function of the battery. The power supply device may include municipal power supply devices, and the electrical device may include a mobile phone or a vehicle.

The second membrane 32 is provided with a blocking groove 34 and an alignment region 33 defined by the blocking groove 34. A projection of the alignment region 33 on the first electrode plate 10 covers the first tab groove 11, that is, the alignment region 33 is arranged opposite to the first tab groove 11. Moreover, an area of the alignment region 33 is equal to an area of the first tab groove 11, or the area of the alignment region 33 is greater than the area of the first tab groove 11.

The alignment region 33 is defined by the blocking groove 34, that is, the blocking groove 34 surrounds the alignment region 33, so that a projection of the blocking groove 34 on the first electrode plate 10 does not coincide with the first tab groove 11, thereby avoiding reducing a thickness of a region where the first tab groove 11 is located, improving the thickness uniformity of the whole electrode assembly, reducing a concentration gradient on the first electrode plate, slowing down diffusion of active lithium on the first electrode plate, further preventing a lithium plating phenomenon at the first tab groove, and improving the safety performance of the battery.

In addition, by providing the blocking groove in this embodiment, compared with a technical solution in which an insulating layer is merely disposed on the alignment region, the blocking groove in this embodiment can further avoid solid-solid diffusion of the active lithium located in the alignment region and active lithium in other regions except the alignment region, that is, the blocking groove can prevent the active lithium located in the alignment region from diffusing to other regions outside the alignment region, and thus can prevent the active lithium located in the alignment region from being transmitted to the first tab groove, thus avoiding the lithium plating phenomenon at the first tab groove and improving the safety performance of the battery.

It is to be noted that the lithium plating phenomenon usually occurs in the charging and discharging process of the battery. Exemplarily, in the charging process of the lithium battery, lithium ions may be separated from a positive electrode active substance under the effect of an electric potential difference of a positive electrode and a negative electrode, and are embedded into a negative electrode graphite layer through a passivation film; and when the lithium battery discharges, the lithium ions may be separated from the negative electrode and embedded into the positive electrode again. However, due to a continuous loss of the active lithium and active material of the positive electrode and the negative electrode in a later period of the cycles of the lithium battery, continuous attenuation of the battery capacity can be caused, so that the concentration gradient is formed in the positive electrode plate and the negative electrode plate. When the concentration gradient reaches a certain value, the active lithium can be subjected to the solid-solid diffusion in the positive electrode plate or the negative electrode plate, lithium ions on the negative electrode plate may precipitate out of the aligned tab groove of the negative electrode plate, and lithium ions in the negative electrode plate may precipitate out of the aligned tab groove of the negative electrode plate, thus forming the lithium plating phenomenon.

In some embodiments, a bottom of the blocking groove 34 can extend to the second current collector 31 or extend into the second membrane 32. Preferably, the bottom of the blocking groove 34 extends to the second current collector 31, that is, the bottom of the blocking groove 34 is a surface of the second current collector 31, so that the alignment region can be insulated, and the solid-solid diffusion between the active lithium located in the alignment region and the active lithium in other regions except the alignment region can be better prevented, thus avoiding the lithium plating phenomenon at the first tab groove and improving the safety performance of the battery.

In this embodiment, as shown in FIG. 7 and FIG. 8, the number of the blocking grooves 34 may be two, and each second membrane 32 is provided with a blocking groove 34, that is, the two blocking grooves 34 are provided in an upper surface and a lower surface of the second electrode plate respectively.

The structure of the blocking groove 34 can be described by two implementations below, and it is to be noted that the following two implementations are only two exemplary feasible methods, and are not intended to limit the structure of the blocking groove.

As shown in FIG. 6 to FIG. 8, as a feasible implementation of the blocking groove, the blocking groove 34 includes a first blocking groove 341, a second blocking groove 342, and a third blocking groove 343.

The first blocking groove 341 may extend along a length direction of the second electrode plate 30, that is, the first blocking groove 341 extends in a direction L in FIG. 6.

The second blocking groove 342 is disposed at one end of the first blocking groove 341, and by taking an orientation shown in FIG. 6 as an example, the second blocking groove 342 may be disposed at a left end of the first blocking groove 341, and a first preset angle is formed between the second blocking groove 342 and the first blocking groove 341.

The third blocking groove 343 is disposed at the other end of the first blocking groove 341, and by taking the orientation shown in FIG. 6 as an example, the third blocking groove 343 may be disposed at a right end of the first blocking groove 341, and a second preset angle is formed between the third blocking groove 343 and the first blocking groove 341.

Ends of the second blocking groove 342 and the third blocking groove 343 facing away from the first blocking groove 341 are aligned with edges of the second electrode plate along a width direction. Taking the orientations shown in FIG. 6 and FIG. 8 as examples, an upper edge of the second blocking groove 342 and an upper edge of the third blocking groove 343 are aligned with an upper edge of the second electrode plate 30, so that a region defined by the blocking grooves completely surrounds the alignment region, so as to improve the blocking effect of the blocking grooves on the transmission of the active lithium located in the alignment region, thus preventing the active lithium located in the alignment region from being transmitted to the first tab groove, avoiding the lithium plating phenomenon at the first tab groove, and improving the safety performance of the battery.

In this embodiment, the first preset angle and the second preset angle range from 85° to 95°, and optionally, the first preset angle and the second preset angle are both 90°, that is, the second blocking groove 342 and the third blocking groove 343 are perpendicular to the first blocking groove 341, so that the blocking groove forms a U-shaped structure, and the manufacturing process of the blocking groove is simplified.

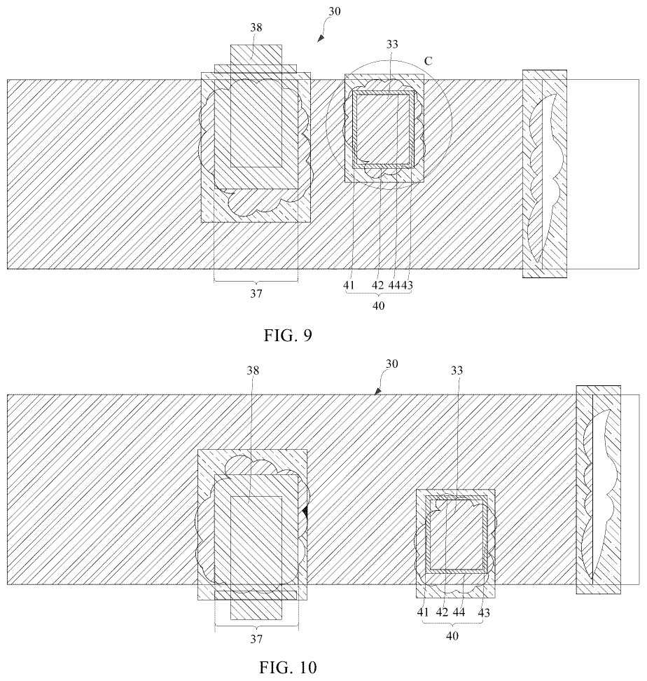

As shown in FIG. 9 to FIG. 11, as another feasible implementation of the blocking groove, the blocking groove 34 may include an annular groove 40, and the annular groove 40 surrounds the alignment region 33.

Taking a plane parallel to the second electrode plate 30 as a cross-section, the cross-section of the annular groove 40 may be in a polygonal shape. For example, the cross-section of the annular groove 40 may be in a rectangular shape, that is, the annular groove 40 may include a first segment 41, a second segment 42, a third segment 43, and a fourth segment 44 connected in sequence, and an edge of the second electrode plate 30 close to the fourth segment 44 has a certain interval from the fourth segment 44, so that the blocking groove forms a square shape.

The cross-section of the annular groove 40 may also be in a circular shape, as long as the annular groove can surround the alignment region 33, so as to achieve the purpose of preventing the active lithium located in the alignment region from being transmitted to regions outside the alignment region of the second electrode plate.

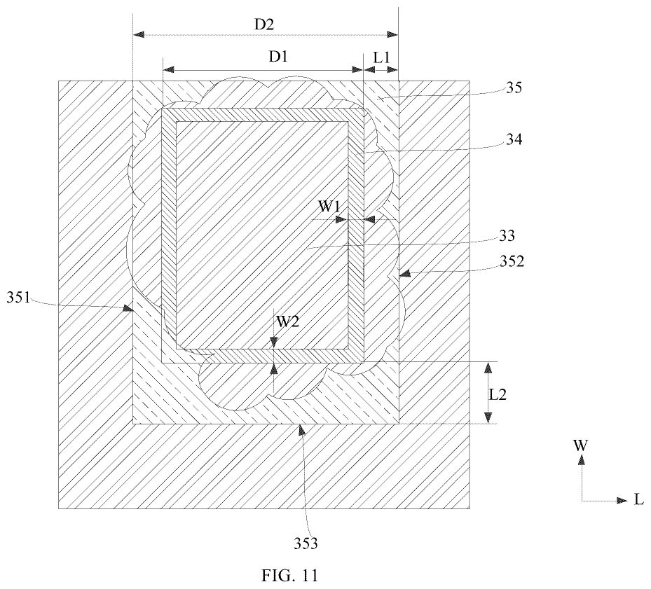

In some embodiments, as shown in FIG. 8 and FIG. 11, for example, along the length direction L of the second electrode plate, a groove width W1 of the blocking groove 34 ranges from 0.1 mm to 2 mm.

If the width of the blocking groove 34 is too large, the area of the blocking groove may be too large, which further causes reduction of the thickness of the region on the second electrode plate where the blocking groove is located, and results in a thickness difference between the region where the blocking groove is located and other regions on the second electrode plate except the blocking groove. The thickness difference tends to increase the concentration gradient of lithium ions in the second electrode plate, and provides a driving force for the transmission of the lithium ions in the second electrode plate, so the lithium plating phenomenon may still exist at the first tab groove.

If the width of the blocking groove is too small, the blocking capacity of the blocking groove may be reduced, and the preparation difficulty of the blocking groove may also be increased.

Therefore, this embodiment limits the width of the blocking groove, not only to prevent the lithium plating phenomenon at the first tab groove, but also to reduce the thickness difference between the region of the electrode assembly where the blocking groove is located and other regions.

It is to be noted that, in this embodiment, the width of the blocking groove may be completely equal or not equal, for example, along the width direction of the second electrode plate, a width W2 of the blocking groove 34 may also range from 0.1 mm to 2 mm.

In some embodiments, the second electrode plate 30 provided in the embodiment is provided with an insulating film 35, and the insulating film 35 covers the blocking groove 34 and the alignment region 33 for sealing the blocking groove 34 and the alignment region 33, thus protecting the blocking groove 34 and the alignment region 33 and preventing the electrolyte from permeating into the blocking groove, wherein the insulating film 35 may include a protective adhesive tape.

Taking an orientation shown in FIG. 9 and FIG. 11 as an example, along the length direction of the second electrode plate 30, the insulating film 35 is provided with a first edge 351 and a second edge 352 arranged opposite to each other, the first edge 351 may be a left edge of the insulating film 35, the second edge 352 may be a right edge of the insulating film 35. A distance between the second edge 352 and a groove edge of the blocking groove 34 close to the second edge 352 ranges from 1 mm to 4 mm, that is, L1 shown in FIG. 9 and FIG. 11 ranges from 1 mm to 4 mm.

Further, the insulating film 35 further includes a third edge 353, that is, the third edge 353 may be a lower edge of the insulating film 35. One end of the third edge 353 is connected to the first edge 351, and the other end of the third edge 353 is connected to the second edge 352. A distance between the third edge 353 and a groove edge of the blocking groove 34 close to the third edge 353 ranges from 1 mm to 4 mm, that is, L2 in FIG. 9 and FIG. 11 ranges from 1 mm to 4 mm.

If L1 and L2 are too large, an area of the insulating film 35 may increase, and the performance of the electrode plate is affected. If L1 and L2 are too small, a gap tends to be generated between the insulating film 35 and the blocking groove 34, so that the active substances located in the blocking groove 34 can easily diffuse to the first tab of the first electrode plate, thereby affecting the performance of the electrode plate. Therefore, this embodiment limits L1 and L2, not only to ensure the performance of the electrode plate, but also to ensure the protection function of the insulating film.

Further, a vertical distance between a groove edge of the blocking groove 34 close to the first edge 351 and the groove edge of the blocking groove close to the second edge 352 is D1, a vertical distance between the first edge 351 and the second edge 352 is D2, and a difference between D2 and D1 ranges from 2 mm to 8 mm, thus ensuring the protection function of the insulating film while ensuring the performance of the electrode plate.

Embodiments or implementations in the specification are described in a progressive manner, each embodiment focuses on the difference from other embodiments, and the same or similar parts of the embodiments are referred to each other.

In the description of the specification, the description with reference to the terms “one implementation”, “some implementations”, “exemplary embodiments”, “an example”, “specific examples” or “some examples” means that the specific feature, structure, material or characteristic described in combination with the implementation or example is included in at least one implementation or example of this application. In the specification, the exemplary description of the above terms does not necessarily refer to the same implementation or examples. Moreover, the described specific features, structures, materials or characteristics can be combined in an appropriate manner in any one or more implementations or examples.

Finally, it is to be noted that: the foregoing embodiments are merely intended to illustrate the technical solutions of this application and are not intended to be a limitation thereof. Although this application is described in detail with reference to the foregoing embodiments, a person of ordinary skill in the art should understand that modifications may be made to the technical solutions recorded in the foregoing embodiments, or equivalent substitutions may be made to some or all of the technical features therein; and these modifications or replacements do not take the essence of the corresponding technical solutions out of the scope of the technical solutions of the embodiments of this application.

What is claimed is:

1. An electrode assembly, comprising: a first electrode plate, a second electrode plate, and a separator located between the first electrode plate and the second electrode plate;
wherein the first electrode plate comprises a first current collector and a first membrane disposed on the first current collector, and the first membrane is provided with a first tab groove; and
the second electrode plate includes a second current collector and a second membrane disposed on the second current collector, the second membrane is provided with a blocking groove and an alignment region defined by the blocking groove, and an orthogonal projection of the alignment region on the first electrode plate covers the first tab groove.

2. The electrode assembly according to claim 1, wherein a bottom of the blocking groove is a surface of the second current collector.

3. The electrode assembly according to claim 2, wherein the blocking groove comprises a first blocking groove extending along a length direction of the second electrode plate, and a second blocking groove and a third blocking groove connected to two ends of the first blocking groove respectively; and
a first preset angle is formed between the second blocking groove and the first blocking groove, a second preset angle is formed between the third blocking groove and the first blocking groove, and ends of the second blocking groove and the third blocking groove facing away from the first blocking groove are aligned with edges of the second electrode plate along a width direction.

4. The electrode assembly according to claim 3, wherein the first preset angle and the second preset angle range from 85° to 95°.

5. The electrode assembly according to claim 2, wherein the blocking groove comprises an annular groove, and the annular groove surrounds the alignment region.

6. The electrode assembly according to claim 5, wherein taking a plane parallel to the second electrode plate as a cross-section, the cross-section of the annular groove is in a polygonal shape, or the cross-section of the annular groove is in a circular shape.

7. The electrode assembly according to claim 1, wherein a width of the blocking groove ranges from 0.1 mm to 2 mm.

8. The electrode assembly according to claim 1, wherein the first electrode plate is a negative electrode plate, and the second electrode plate is a positive electrode plate.

9. The electrode assembly according to claim 1, wherein the second electrode plate is provided with an insulating film, and the insulating film covers the blocking groove and the alignment region.

10. The electrode assembly according to claim 9, wherein along the length direction of the second electrode plate, the insulating film is provided with a first edge and a second edge arranged opposite to each other, and a distance between the second edge and a groove edge of the blocking groove closest to the second edge ranges from 1 mm to 4 mm.

11. The electrode assembly according to claim 10, wherein the insulating film further comprises a third edge, one end of the third edge is connected to the first edge, and the other end of the third edge is connected to the second edge; and
a distance between the third edge and a groove edge of the blocking groove closest to the third edge ranges from 1 mm to 4 mm.

12. The electrode assembly according to claim 11, wherein a vertical distance between a groove edge of the blocking groove closest to the first edge and the groove edge of the blocking groove closest to the second edge is D1, a vertical distance between the first edge and the second edge is D2, a difference between D2 and D1 ranges from 2 mm to 8 mm.

13. A battery, comprising: a case and an electrode assembly disposed in the case, wherein the electrode assembly comprises a first electrode plate, a second electrode plate, and a separator located between the first electrode plate and the second electrode plate;
wherein the first electrode plate comprises a first current collector and a first membrane disposed on the first current collector, and the first membrane is provided with a first tab groove; and
the second electrode plate includes a second current collector and a second membrane disposed on the second current collector, the second membrane is provided with a blocking groove and an alignment region defined by the blocking groove, and an orthogonal projection of the alignment region on the first electrode plate covers the first tab groove.

14. The battery according to claim 13, wherein a bottom of the blocking groove is a surface of the second current collector.

15. The battery according to claim 14, wherein the blocking groove comprises a first blocking groove extending along a length direction of the second electrode plate, and a second blocking groove and a third blocking groove connected to two ends of the first blocking groove respectively; and
a first preset angle is formed between the second blocking groove and the first blocking groove, a second preset angle is formed between the third blocking groove and the first blocking groove, and ends of the second blocking groove and the third blocking groove facing away from the first blocking groove are aligned with edges of the second electrode plate along a width direction.

16. The battery according to claim 15, wherein the first preset angle and the second preset angle range from 85° to 95°.

17. The battery according to claim 14, wherein the blocking groove comprises an annular groove, and the annular groove surrounds the alignment region.

18. The battery according to claim 17, wherein taking a plane parallel to the second electrode plate as a cross-section, the cross-section of the annular groove is in a polygonal shape, or the cross-section of the annular groove is in a circular shape.

19. The battery according to claim 18, wherein a width of the blocking groove ranges from 0.1 mm to 2 mm.

20. An electrical device, comprising the battery as claimed in claim 13.
